(19) United States
(12) Patent Application Publication
(10) Pub. No.: US 2004/0114339 A1
(43) Pub. Date: Jun. 17, 2004

(54) Illumination apparatus for optical instrument

(75) Inventor: Kunihisa Obi, Tokyo (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/721,383

(22) Filed: Nov. 26, 2003

(30) Foreign Application Priority Data
Nov. 29, 2002 (JP) 2002-348547
May 28, 2003 (JP) 2003-151125

(51) Int. Cl. G01D 11/28

(52) U.S. Cl. 362/23; 362/331

(57) ABSTRACT

The present invention is directed to provide an illumination apparatus for an optical instrument which is small in size, has great durability, and can be easily manufactured. The illumination apparatus for an optical instrument is characterized by comprising an illumination means outputting illumination light and an optical element which is positioned on the optical axis of the illumination light outputted from the illumination means and which is made of organic/inorganic composite material containing a component having a glass-transition temperature higher than 150° C. as its organic component.

### BACKGROUND OF THE INVENTION

The present invention relates to an illumination apparatus for an optical instrument and, more particularly, to an illumination apparatus for an optical microscope or a projector.

An illumination apparatus for an optical microscope or a projector has conventionally been known as one of illumination apparatuses for optical instruments with an illumination optical system for illuminating an object such as a sample and a document.

As an example of such illumination apparatuses for optical instruments, there is an illumination apparatus for an incident-light illumination microscope as disclosed in Japanese Patent Unexamined Publication No. 2001-125002.

An example of incident-light illumination microscope is illustrated in FIG. 6. As shown in FIG. 6, the incident-light illumination microscope 61 has an illumination apparatus 63 which is provided inside with an illumination optical system 64 for projecting light from a light source (light source lamp) 62. The illumination light passing through the illumination optical system 64 is introduced to an illumination unit 65 attached to a moving means 66 where the illumination light is introduced to the optical path. The illumination light reflected at the illumination unit 65 is incident on an objective lens 67, thereby illuminating a sample 68 on a stage 69.

An image of the sample 68 on the stage 69 is displayed through an imaging unit 70 arranged above the incident-light illumination microscope 61 onto an image display 71 connected to the imaging unit 70, thus allowing observation of the sample.

In the illumination apparatus having the aforementioned structure, the illumination optical system 64 disposed in front of the light source 62 employs lenses made of a material such as optical glass or optical plastics.

On the other hand, in case of using a plastic lens made of acrylic resin in an optical system of an illumination apparatus for a fluorescent microscope or an ultraviolet microscope for observation of a sample with light in the ultraviolet wavelength range, the transmission range of wavelength effective for observation is only about 380 nm or less. In case of using a glass lens, the transmittance of illumination light generally abruptly diminishes from a wavelength of about 330 nm so that the glass lens hardly transmits light in the ultraviolet wavelength range. For this reason, it is necessary to employ material such as quartz or fluorite in an optical system of such illumination apparatus.

In an illumination apparatus for an optical instrument using light in the ultraviolet wavelength range as mentioned above, lenses made of material such as quartz or fluorite are employed in its illumination optical system. However, these materials are unworkable relative to the grinding and polishing work compared to the optical glass employed in an illumination apparatus for observation with light in the visible wavelength range and, in addition, lenses made of the materials are very expensive. Therefore, such lenses are difficult to be employed in middle-level optical microscopes.

For reducing the size of an illumination apparatus for an optical instrument such as an incident-light illumination microscope or a projector, it is desired to reduce the distance between a light source and a lens of its illumination optical system. However, as the distance between the light source and the lens of the illumination optical system is reduced, the temperature near the light source increases to nearly 150° C. because of radiation heat from the light source so that a plastic lens having a glass-transition temperature of about 100-150° C. is subjected to deterioration in optical characteristics due to heat deformation, yellowing due to thermal oxidation, or yellowing due to photo oxidation attributable to exposure to light at a short wavelength radiated form the light source, thus affecting the observation.

From this point of view, a glass lens does not have the aforementioned problems of deterioration in optical characteristics and yellowing due to high temperature. However, the glass lens has another problem of making the manufacturing process complex compared to the plastic lens.

It is an object of the present invention to solve the aforementioned problems and to provide an illustration apparatus for an optical instrument which is provided with an optical element which exhibits excellent transmittance relative to light in the ultraviolet wavelength range and does not deteriorate in optical characteristics by heat deformation or yellowing even if the element is exposed to high temperature near a light source lamp or exposed to light at a short wavelength radiated from the light source lamp wherein lenses of the optical element are easily manufactured so as to allow mass production, thereby enabling reduction in cost and size of the illumination apparatus.

It is another object of the present invention to provide an illustration apparatus for an optical instrument, even when it does not use light in the ultraviolet wavelength range, which is provided with an optical element which does not deteriorate in optical characteristics by heat deformation or yellowing even if the element is exposed to high temperature near a light source lamp or exposed to light at a short wavelength radiated from the light source lamp and is easily manufactured, thereby enabling reduction in size and cost of the illumination apparatus.

### BRIEF DESCRIPTION OF THE DRAWINGS

FIG. 1 is an illustration showing an illumination optical system for an optical microscope according to an embodiment as an illumination apparatus for an optical instrument of the present invention,

FIG. 2 is an enlarged view of a collector lens 2 employed in the illumination optical system for the optical microscope shown in FIG. 1,

FIG. 3 is an illustration showing a variation of the illumination optical system for the optical microscope shown in FIG. 1,

FIG. 4 is an illustration showing an illumination optical system for a projector,

FIG. 5 is an illustration showing an illumination apparatus for an optical microscope, and

FIG. 6 is an illustration for explaining an example of an incident-light illumination microscope.

### SUMMARY OF THE INVENTION

A first illumination apparatus for an optical instrument of the present invention is an illumination apparatus comprising an illumination light source as the illumination means outputting illumination light and at least one optical element which is positioned on the light path of the illumination light eliminated from the illumination light source and which is made of organic/inorganic composite material composed of organic component and inorganic component.

As mentioned above, the optical element made of the organic/inorganic composite material composed of the organic component and the inorganic component can be manufactured in the same manner as an optical element made of only organic component such as a plastic lens, but has improved heat resistance and is not subjected to heat deformation and yellowing due to the light source lamp. Therefore, the distance between the optical element and the light source lamp can be shortened, thus enabling reduction in size and cost of the illumination apparatus.

A second illumination apparatus for an optical instrument of the present invention is an illumination apparatus comprising an illumination light source and at least one optical element which is positioned on the light path of the illumination light eliminated from the illumination light source and which is made of organic/inorganic composite material composed of organic component having a glass-transition temperature higher than 150° C. and inorganic component.

The optical element made of the organic component and the inorganic component can be manufactured in the same manner as an optical element made of only organic component, but can keep its heat resistance for a long period of time of the light source lamp usage and is not subjected to heat deformation and yellowing due to the light source lamp. Therefore, the distance between the optical element and the light source lamp can be shortened, thus enabling reduction in size and cost of the illumination apparatus.

The inorganic component of the organic/inorganic composite material for forming the optical element arranged in the first or second illumination apparatus for an optical instrument is an organic silicide represented by the following general formula (1) or a hydrolysate thereof.

R¹ₐR²_{b}Si(OR³⁾_{4-a-b} General Formula (1)

(R¹ and R² are the same or different organic groups, R¹ is an alkyl group, an alkyl halide group, an aryl group or an aryl halide group of which carbon number is between 1 and 6, and “a” and “b” are integers between 0 and 2 and “a+b” is an integer between 0 and 2.)

The inorganic component of the organic/inorganic composite material for forming the optical element arranged in the first or second illumination apparatus for an optical instrument is a metal alkoxide represented by the following general formula (2) or a hydrolysate thereof.

M¹(OR⁴)ₙ General Formula (2)

(M¹ is at least one of metal elements which is selected from a group consisting of Al, Be, Ge, Hf, La, Mg, Sc, Ta, Ti, V, Y, Zn, and Zr, R⁴ is an alkyl group, an alkyl halide group, an aryl group or an aryl halide group of which carbon number is between 1 and 6, and “n” is a positive integer as a valence of the metal element M¹.)

A third illumination apparatus for an optical instrument of the present invention is an illumination apparatus comprising an illumination light source as the illumination means outputting illumination light and at least one optical element which is positioned on the light path of the illumination light eliminated from the illumination light source and which is made of organic/inorganic composite material composed of organic component having a glass-transition temperature higher than 150° C. when the organic component is hardened alone and inorganic component capable of transmitting lights in a range including the visible wavelength range and the ultraviolet wavelength range.

As mentioned above, the optical element made of the organic/inorganic composite material composed of the inorganic component and the organic component can be manufactured in the same manner as an optical element made of only organic component, but can keep its heat resistance for a long period of time of the light source lamp usage and is not subjected to heat deformation and yellowing due to the light source lamp. Therefore, the distance between the optical element and the light source lamp can be shortened and the optical element can be adopted to an illumination apparatus for microscope observation such as a fluorescent microscope or an ultraviolet microscope, thus enabling reduction in size and cost of the illumination apparatus.

The inorganic component of the organic/inorganic composite material for forming the optical element arranged in the third illumination apparatus for an optical instrument is an organic silicide represented by the following general formula (3) or a hydrolysate thereof.

R¹ₐR²_{b}Si(OR³)_{4-a-b} General Formula (3)

(R¹ and R² are the same or different organic groups, R³ is an alkyl group, an alkyl halide group, an aryl group or an aryl halide group of which carbon number is between 1 and 6, and “a” and “b” are integers between 0 and 2 and “a+b” is an integer between 0 and 2.)

The inorganic component of the organic/inorganic composite material for forming the optical element arranged in the third illumination apparatus for an optical instrument is a metal alkoxide represented by the following general formula (4) or a hydrolysate thereof.

M²(OR⁴)ₘ General Formula (4)

(M² is at least one of metal elements which is selected from a group consisting of Al, Be, Hf, La, Mg, Sc, Y, and Zr, R⁴ is an alkyl group, an alkyl halide group, an aryl group or an aryl halide group of which carbon number is between 1 and 6, and “m” is a positive integer as a valence of the metal element M².)

### DESCRIPTION OF THE PREFERRED EMBODIMENT

An optical element employed in an illumination apparatus for an optical instrument according to the present invention is made of organic/inorganic composite material which is transparent in a wavelength range of illumination light to be used and exhibits heat resistance to high temperature of 150° C. or more near a light source lamp due to heat radiated from the light source lamp for illumination and exhibits light resistance to light exposure by the light source lamp. The organic/inorganic composite material is made of organic component and inorganic component which are mixed in complex with each other on molecular level or nanoscale level and has a structure in which a polymer matrix formed of organic backbones and a matrix formed of inorganic backbones are intervolved and interpenetrated into each other (IPN structure), a structure in which inorganic nanoscale fine particles are dispersed in a polymer matrix formed of organic backbones (composite structure), a structure in which a monomer or oligomer formed of organic backbones and a monomer or oligomer having inorganic element are copolymerized (copolymerized structure), or a composite structure of two or more of these structures. In such a structure, some interactions act between the organic component and the inorganic component wherein the interactions include hydrogen bonding, dispersion force, intermolecular force such as coulomb force, covalent bonding, ionicbonding, and/or attraction because of interaction between π electron clouds.

In the organic/inorganic composite material used in lenses of the illumination apparatus for the optical instrument according to the present invention, examples of thermoplastic resin preferable as the organic component include amorphous polyorefine resin, norbornene resin, polycarbonate, polyetherimide, polyetheramideimide, polyether sulfone, thermoplastic polyimide, and polyarylate.

Examples of the thermosetting resin include epoxy resin, urethane resin, fluorocarbon resin, acrylate resin, polyimide, and silicone resin. Particularly preferable one among these is silicone resin expressed by:

HO(SiR⁵₂O)ₙH

(R⁵ represents the same or different organic group, n represents a positive integral number) or

CH₂═CHSiR⁶₂O(SiR⁷₂O)ₘ(SiR⁷CH═CH₂O)₁SiR⁶₂CH═CH₂

(R⁶, R⁷ represent methyl group or phenyl group which are independent from each other, m and l represent positive integral numbers)

This silicone resin exhibits heat resistance to high temperature of 200° C. or more even when singly used, has good solubility relative to metal alkoxide, metal acetylacetonate, or metal carboxylate as the inorganic component, and offers flexibility to the organic/inorganic composite material, thereby preventing the lens from being broken during hardening in the lens forming process or during thermal expansion or contraction due to heat emitted from the light source lamp when used as a lens of the illumination apparatus and improving the impact resistance of the lens. In addition, the silicone resin can transmit lights from visible light to illumination light at a wavelength of 250 nm. Therefore, the silicone resin is preferable organic component.

Preferable examples of the inorganic component include inorganic polymer molecules having metalloquioxane backbones obtained by sol-gel reaction as of at least one kind of organic metal components selected from a group consisting of various metal alkoxide, metal acetylacetonate, and metal carboxylate such as Al, Be, Ge, Hf, La, Mg, Sc, Si, Ta, Ti, V, Y, Zn, and Zr. Particularly preferable examples among these are Al, La, Sc, Si, Ta, Ti, and Zr.

As a method of synthesizing organic/inorganic composite material, there is a method for producing a hardened body made of organic composite material having interpenetrating networks in which organic component and inorganic component are interpenetrated to each other by mixing a monomer or oligomer of thermosetting resin of organic component with metal alkoxide as the inorganic component and, if necessary, a solvent, a catalyst, and/or a hardener, and proceeding the polymerizing reaction of resin monomer and the sol-gel reaction of metal alkoxide. According this method, the reaction speed is adjustable according to the kind and the adding amount of solvent and catalyst, the fluidity of the material during the lens formation from the synthesized organic/inorganic composite material is adjustable according to the kind and the adding amount of solvent, or the method and condition of the hardening by heat or energy irradiation during the lens formation from the synthesized organic/inorganic composite material are adjustable according to the kind and the adding amount of the hardener.

As another method for synthesizing organic/inorganic composite material, there is a method of uniformly dispersing fine particles of metal oxide, metal sulfide, metal nitride, metal carbide, metal halide, or metal elementary substance, as inorganic component of which the diameter of fine particles is 100 nm or less, preferably 30 nm or less, which is significantly smaller than the wavelength of illumination light, into the organic component, with keeping the diameter of the fine particles significantly smaller than the wavelength of illumination light.

In this method, inorganic fine particles are uniformly dispersed into the organic component. For example, besides a common mixing method, there is a method of inducing a sol-gel reaction of metal alkoxide in organic component so as to produce inorganic fine particles and a method of deoxidizing metal component after mixing an organic resin monomer and a metal complex so as to produce metal fine particles and polymerize organic component simultaneously. The preprocessing may be allowed by surfacing the fine particles to increase the affinity to the organic component.

As a result of reinforcement of the organic component with the inorganic component, the organic/inorganic composite material obtained as mentioned above has improved thermal characteristics such as the improved heat resistance and the reduced coefficient of thermal expansion. Therefore, the organic/inorganic composite material has a glass-transition temperature higher than 150° C. and is thus subjected to neither the heat deformation nor the yellowing. Since, in the organic/inorganic composite material, the organic component and the inorganic component interact with each other on molecular level or nanoscale level, the molecular vibration of main chain backbone of the organic component may be prevented, thereby improving the characteristics.

In the present invention, the glass-transition temperature is measured according to “Testing Methods for Transition Temperatures of Plastics” defined as JIS K7121.

When the organic/inorganic composite material is used as a lens of an illumination apparatus for an optical instrument, the organic/inorganic composite material is required to be transparent in the wavelength range to be used. When the lens is made of organic/inorganic composite material in which the organic component is fluorocarbon resin or silicone resin and the inorganic component is an organic metallic compound containing at least one of Al, Be, Hf, La, Mg, Sc, Si, Y, and Zr, the lens can transmit illumination lights in a wider range including the visible wavelength range and the ultraviolet wavelength range, i.e. from 750 nm to 350 nm. Especially, a lens made of organic/inorganic composite material in which the inorganic component is an organic metallic compound containing one of Be, Mg, and Si among the above can transmit illumination lights in a wider range including the visible wavelength range and the ultraviolet wavelength range, i.e. from 750 nm to 250 nm and is therefore capable of being used as the lens for an illumination optical system for an ultraviolet microscope or a deep ultraviolet microscope.

Since, in the lens for an illumination apparatus made of the organic/inorganic composite material according to the present invention, the entire refractive index and the wavelength dispersion (Abbe number) of the organic/inorganic composite material can be adjustable according to the ratio between the organic component and the inorganic component and/or the kinds of the organic component and the inorganic component. Therefore, when the lens is made of the organic/inorganic composite material having high refractive index, the lens can have smaller size and shorter focal distance, thereby achieving the reduction in size of the optical instrument.

An embodiment of the illumination apparatus for the optical instrument of the present invention will be described with reference to the attached drawings.

FIG. 1 is an illustration showing an illumination optical system for an optical microscope as an embodiment of the illumination apparatus for the optical instrument according to the present invention.

The system comprises a collector lens 2 for collimating light from a light source lamp 1 into almost parallel light beams and a condenser lens 3 for focus the parallel illumination light beams from the collector lens 2. The focused illumination light beam is focused on a sample 4 arranged on substantially the same axis as the collector lens 2 and is observed via an objective lens 5 for sample observation. The light source lamp 1, the collector lens 2, the condenser lens 3, and the objective lens 5 are all aligned on an optical axis 6.

The collector lens 2 and the condenser lens 3 are lenses made of the organic/inorganic composite material. When a conventional lens made of organic plastic is used as the collector lens 2 and is located near the light source lamp 1 so as to increase the temperature to about 150° C., the lens may be subjected to heat deformation and/or yellowing due to heat. However, the collector lens 2 made of the organic/inorganic composite material of the present invention has heat resistance to high temperature exceeding 150° C. and is thus subjected to neither the heat deformation nor the yellowing.

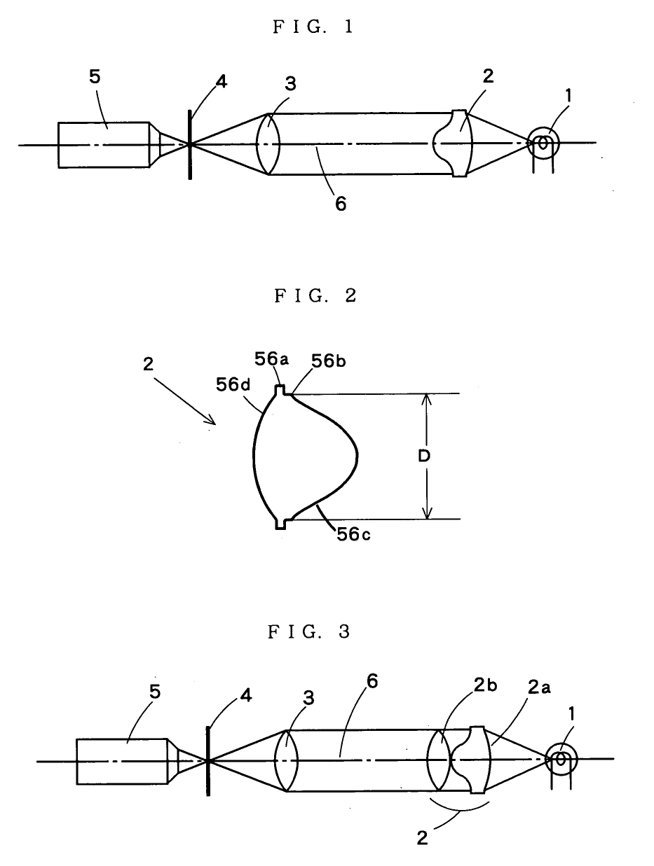

FIG. 2 is an enlarged view of a collector lens 2 employed in the illumination optical system for the optical microscope shown in FIG. 1.

The collector lens 2 has a flange 56a and forms a core diameter portion 56b aligned with the optical axis of the lens and which has a dimension indicated by “D” in FIG. 2. In addition, the collector lens is composed of an aspherical portion 56c and a spherical portion 56d.

The collector lens 2 has such a configuration that the outer diameter D of the core diameter portion 56b is about 40 mm, the thickness of the core diameter portion 56b is about 2 mm, the distance between the top of the aspherical portion 56c and the top of the spherical portion 56d, i.e. the thickness of lens on the optical axis, is about 30 mm, the outer diameter of the flange 56a is 50 mm, and the thickness of the flange 56a is about 2 mm. As for the manufacture of such a lens of which the outer diameter is large as 35 mm or more and the uneven thickness ratio, i.e. the ratio of the thickness of the lens on the optical axis to the sum of the thickness of the core diameter portion 56b and the thickness of the flange 56a as the outer-side thickness of the lens, is 7.5 which is a large value because it is larger than 6, and which has aspherical surface, there is a problem of taking too much man hours to manufacture the lens when optical glass is used as the material and the lens is manufactured by the grinding and polishing work.

On the other hand, when the lens is manufactured by press molding, there is a problem of poor yield because it is difficult to form the aspherical surface and the spherical surface as designed without generating shrinkage cavity or the like.

However, by using the organic/inorganic complex material as the material according to the present invention, the lens can be formed in the same manner as a plastic lens.

Though both the collector lens 2 and the condenser lens 3 may be made of the organic/inorganic composite material, the organic/inorganic composite material may be used as the material only for the collector lens 2 when the heat level of the light source lamp 1 is not so large so that only the temperature of the lens adjacent to the light source lamp 1 is increased to a predetermined high temperature.

FIG. 3 is an illustration showing a variation of the illumination optical system for the optical microscope shown in FIG. 1. This variation is different from the illumination optical system of FIG. 1 in that the collector lens 2 is composed of two lenses, i.e. a collector lens 2a and a collector lens 2b. The collector lens 2a as an optical lens on the light source lamp 1 side is made of the organic/inorganic composite material, while the collector lens 2b and the condenser lens 3 are made of optical plastic or optical glass. The material to be employed is suitably selected depending on the heat level of the light source lamp 1.

Not only for the illumination optical systems for optical microscopes shown in FIG. 1 and FIG. 3, an inexpensive illumination apparatus for an optical instrument can be manufactured without deteriorating its optical characteristics due to heat emitted from a light source lamp 1 by using a lens (or lenses) made of the organic/inorganic composite material as at least one of lenses arranged near the light source lamp in the illumination apparatus for the optical instrument.

As an example of the organic/inorganic composite material to be used for the lens of the illumination optical system for the optical microscope as shown in FIG. 1, for example, there is an organic/inorganic composite material which contains, as the inorganic component, methyltrimethoxysilane of the general formula (1) of which R¹ is CH₃, R³ is CH₃, a=1, and b=0, and as the organic component, allyl ester oligomer containing alicyclic carboxylic acid having allyl ester group at end, acryl oligomer, and radical polymerization initiator.

As an example of the method of forming the aforementioned organic/inorganic composite material, there is a method of mixing methyltrimethoxysilane with lower alcohol such as ethanol as a diluent and water so as to cause hydrolysis reaction and condensation polymerization of the methyltrimethoxysilane, after that, removing by-products, adding allyl ester olygomer containing alicyclic carbosylic acid, acryl oligomer, and radical polymerization initiator to fabricate an organic/inorganic composite material, pouring the obtained raw organic/inorganic composite material into a predetermined mold, and hardening the organic/inorganic composite material with energy such as heat or ultraviolet ray.

As another example of the organic/inorganic composite material to be used for the lens of the illumination optical system for the ultraviolet microscope, for example, there is an organic/inorganic composite material which contains, as the inorganic component, methyltrimethoxysilane of the general formula (3) and aluminum triisopropoxide of the general formula (4) of which M² is Al, R⁴ is —C₃H₇, and m=3, and as the organic component, amorphous fluorocarbon resin composition such as perfluoro alkyl vinyl ether, tetrafluoroethylene, hexafluoropropylene, and perfluoroalyl vinyl ether. The organic/inorganic composite material made from these components can transmit deep ultraviolet ray about 200 nm.

Hereinafter, an embodiment of an illumination apparatus for another optical instrument will be described with reference to the attached drawings.

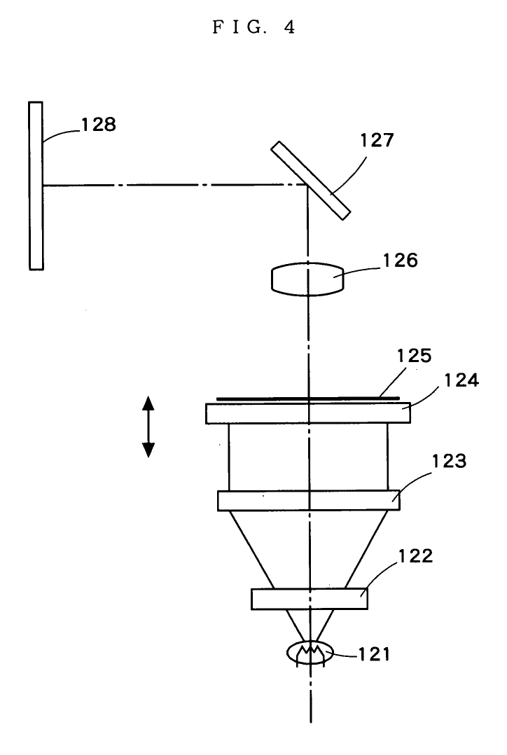

FIG. 4 is an illustration showing an illumination optical system for a projector.

Illumination light emitted from a lamp 121 is diffused by a Fresnel lens 122 of diverging type such as a concave lens and is collimated into parallel light beams by a lens 123 of conversing type such as a convex lens so as to illuminate a sample 125 placed on a plate glass 124. Examples of the sample 125 include a transparent sheet on which a character, an illustration, and/or a table are written. Illumination light passing through the sample 125 is magnified by a projector lens 126, is reflected at a mirror 127, and is projected on a screen 128. The sample 125 is focused on the screen 128 by moving the plate glass 124 up and down in the arrow directions relative to the projector lens 126.

Fresnel lens 122 is a lens made by molding the organic/inorganic composite material while the lens 123 of conversing type is a Fresnel lens made by molding optical plastic material. Since the temperature around the light source lamp 121 rises to nearly 150° C., if a conventional optical plastic is used for the Fresnel lens 122, the lens 122 may be subjected to heat deformation and/or yellowing due to heat. However, since the organic/inorganic composite material has a heat resistance to 200° C. or more, the lens is in no danger of heat deformation.

As for the Fresnel lens of the illumination optical system for the projector as shown in FIG. 4, it is required to process it to have a plate configuration having refined concaves and convexes formed in its surface. It is quite difficult to process optical glass to have such a configuration. However, the organic/inorganic composite material can be processed to have such a configuration in the same manner as optical plastics.

As the organic/inorganic composite material used for the Fresnel lens 122 of the illumination optical system for a projector shown in FIG. 4, the same organic/inorganic composite material as used in the illumination optical system for the optical microscope shown in FIG. 1 or FIG. 3 can be used.

Though the above description has been made for a case that the Fresnel lens is used as the lens of diverging type in the illumination optical system for the projector, a spherical lens may be used.

Hereinafter, the present invention will be described with reference to Examples.

### Example 1

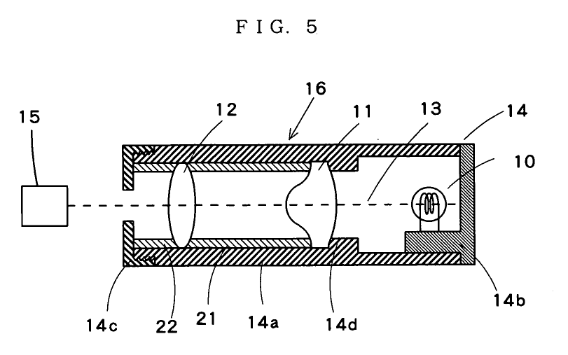

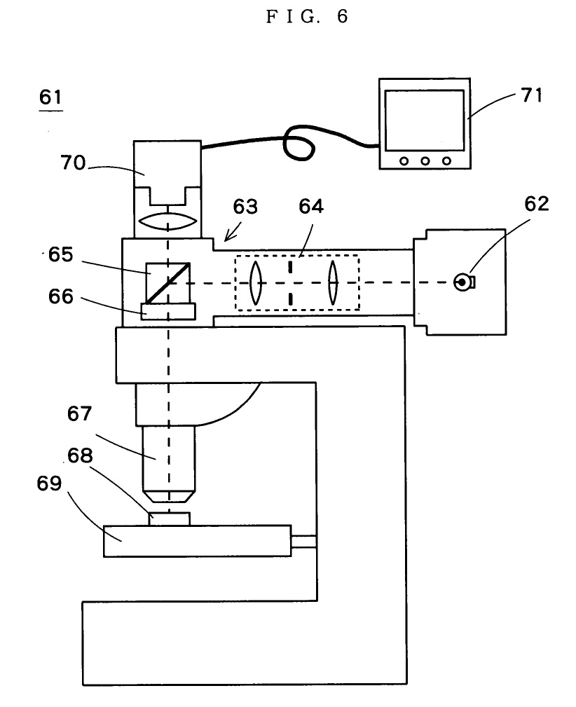

An embodiment of the illumination apparatus according to the present invention is shown in FIG. 5.

An illumination apparatus 16 comprises an illumination optical system and a housing 14 accommodating the illumination optical system. The illumination light from a light source lamp 10 is collimated into substantially parallel light beams by a collector lens 11 and is converged by a condenser lens 12 to a spectral detector 15 for evaluating lenses existing on the optical axils 13. The light source lamp 10, the collector lens 11 and the condenser lens 12 of the illumination optical system are accommodated in the housing 14 of the illumination apparatus 16.

The collector lens 11 and the condenser lens 12 are made of the organic/inorganic composite material. The spectral detector 15 has a function of measuring the strength of light from the light source lamp for every wavelength.

The housing 14 comprises a cylindrical housing body 14a, a lamp holding portion 14b to which the light source lamp 10 is mounted, and a fitting member 14c for mounting the collector lens 11 and the condenser lens 12 to the housing body 14a at an end from which the illumination light outputted from the light source lamp 10 is projected.

The lamp holding portion 14b is provided for aligning the light source lamp 10 with the optical axis of the illumination apparatus and is detachable relative to one end of the housing body 14a for allowing the replacement of the lamp.

A spacer ring 21 is disposed between the collector lens 11 and the condenser lens 12 so that the flange of the collector lens 11 is sandwiched and fixed between the spacer ring 21 and a center projection 14d inwardly projecting from the housing body 14a. Disposed between the condenser lens 12 and the fitting member 14c is a press ring 22. The condenser lens 12 is fixed within the housing body 14a by pressing the press ring 22 toward the condenser lens 12 with screwing the fitting member 14c to the housing body 14a.

The collector lens 11 and the condenser lens 12 are made of the organic/inorganic composite material containing 30.7 g of 3-glycidyloxypropylmethyldimethoxy silane as its inorganic component, 20.0 g of epoxy resin monomer of bisphenol A type (Epikote 828, available from Japan Epoxy Resins Co., Ltd.) as its organic component, and 3.9 g of tetrapentamine as its hardener by mixing these components, pouring the mixture into a lens mold, and hardening it at a temperature of 40° C., thereby manufacturing lenses of Example 1.

Continuous lighting test was conducted by leaving the illumination apparatus at room temperature for 1000 hours with keeping the light source lamp 10 of the illumination apparatus 16 lighted. The temperature about the collector lens 11 near the light source lamp 10 reached its equilibrium state at 150° C. in 60 minutes after lighting.

The temperature about the collector lens 11 was measured by a thermocouple attached to the surface of the lens on the light source lamp 10 side at a position off the optical axis 13 of the collector lens 11.

The temperature about the condenser lens 12 was in the equilibrium state at 80° C. The strength of lights in a wavelength range from 200 nm to 800 nm was measured by the spectral detector 15 before and after the test. As to wavelengths of 250 nm, 450 nm, and 650 nm, the retentions of strength of lights at the respective wavelengths after the test when those before the test are assumed as 100% are shown in Table 1.

The temperature about the condenser lens 12 was measured by a thermocouple attached to the surface of the condenser lens at a position off the optical axis 13 of the condenser lens 12.

Since the collector lens and the condenser lens of this embodiment do not transmit light in the deep ultraviolet wavelength range even before the continuous lighting test, the study was made for variation in strength of lights at wavelengths longer than 350 nm. As shown in Table 1, there was no deterioration in strength of illumination lights at 450 nm and 650 nm after the test relative to those before the test. In addition, yellowing of the collector lens 11 and the deformation of the lens surface were not observed even after the test.

### Example 2

A collector lens and a condenser lens were manufactured in the same manner as Example 1 except using the following organic/inorganic composite material.

The organic/inorganic composite material comprised 27.2 g of vinyl trimethoxysilane and 20.4 g of aluminum triisopropoxide as its inorganic component, 40.0 g of organo polysiloxane containing vinyl group represented by CH₂═CHSi(CH₃)₂O[Si(CH₃)₂O]ₙ[SiCH₃CH═CH₂O]ₘSi(CH₃)₂CH═CH₂(n+m is an integer between 50 and 200) and 40.0 g of organo hydrogen polysiloxane represented by (CH₃)₃SiO[Si(CH₃)₂O]ₖ[SiHCH₃O]₁Si(CH₃)₃ (k+1is an integer between 5 and 10) as its organic component, and 0.4 g of platinum compound as its hardener.

After a compound of vinyl trimethoxysilane and aluminum triisopropoxide in which hydrolysis reaction and condensation polymerization therebetween were partially caused was added into a mixture of the organo polysiloxane containing vinyl group, organo hydrogen polysiloxane, and the chloroplatinic acid, these were poured into a lens mold and hardened at a temperature of 80° C., thereby manufacturing lenses of Example 2.

The continuous lighting test for 1000 hours was also conducted in the same manner as Example 1. As to wavelengths of 250 nm, 450 nm, and 650 nm, the retentions of strength of lights at the respective wavelengths after the test when those before the test are assumed as 100% are shown in Table 1.

As shown in Table 1, there was no deterioration in strength of illumination lights at 250 nm, 450 nm, and 650 nm after the test relative to those before the test. In addition, neither yellowing nor heat deformation was observed both on the collector lens and the condenser lens which were made of the organic/inorganic composite material.

### Example 3

A collector lens and a condenser lens were manufactured in the same manner as Example 1 except using the following organic/inorganic composite material.

As its inorganic component, 18 g of trifluoropropyltrimethoxysilane and 3 g of methyl trimethoxysilane were used and, as its organic component, 30.0 g of fluorothermoplastic resin (Dyneon THV X610A, available from Dyneon) made of a polymer of tetrafluoroethylene, hexafluoropropylene and vinylidene fluoride was used.

After a compound of trifluoropropyltrimethoxysilane and methyl trimethoxysilane in which hydrolysis reaction and condensation polymerization therebetween were partially caused was added into a solution of fluorothermoplastic resin (Dyneon THV X610A, available from Dyneon) dissolved in methyl ethyl ketone so that the inorganic component and the organic component were mixed, the mixture was poured into a lens mold and heated to a temperature of 60° C. with generally volatilizing the methyl ethyl ketone, thereby molding and manufacturing lenses of Example 3.

The continuous lighting test for 1000 hours was also conducted in the same manner as Example 1. The strength of light of every wavelength before and after the test were measured by the spectral detector 15. As to wavelengths of 250 nm, 450 nm, and 650 nm, the retentions of strength of lights at the respective wavelengths after the test when those before the test are assumed as 100% are shown in Table 1.

As shown in Table 1, there was no deterioration in strength of illumination lights at 250 nm, 450 nm, and 650 nm after the test relative to those before the test. In addition, neither yellowing nor heat deformation was observed both on the collector lens and the condenser lens which were made of the organic/inorganic composite material.

### COMPARATIVE EXAMPLE 1

An illumination apparatus was manufactured in the same manner as Example 1 except that a collector lens and a condenser lens were made by mixing 44.0 g of methyl methacrylate with 0.4 g of 2,2′-azobis(isobutyronitrile) as its hardener and molding the mixture at a temperature of 60° C.

The continuous lighting test for 1000 hours was also conducted in the same manner as Example 1. The strength of light of every wavelength before and after the test were measured by the spectral detector 15. As to wavelengths of 250 nm, 450 nm, and 650 nm, the retentions of strength of lights at the respective wavelengths after the test when those before the test are assumed as 100% are shown in Table 1.

As compared to Example 1, the drop in strength of light at a short wavelength of 450 nm was heavier and the yellowing can be recognized even with the observer's eyes. Particularly, the yellowing of the collector lens which was in the high temperature state was severe.

TABLE 1
Retention of strength of light at each wavelength

| | 250 nm | 350 nm | 450 nm | 650 nm |
|---|---|---|---|---|
| Example 1 | Not transmit | 35 | 80 | 98 |
| Example 2 | 96 | 98 | 98 | 98 |
| Example 3 | 95 | 98 | 98 | 98 |
| Comparative | Not transmit | Not transmit | 65 | 96 |
| Example 1 | | | | |

As mentioned above, the present invention employs, instead of plastic lenses having problems in use due to radiation heat emitted from a light source, lenses made of organic/inorganic composite material which can be manufactured in the same production process as the plastic lenses in an illumination apparatus for an optical instrument such as an incident-light illumination microscope or a projector, thereby providing an illumination apparatus which is prevented from deterioration in optical characteristics due to heat deformation and from yellowing due to thermal oxidation, or is prevented from yellowing due to photo oxidation attributable to exposure to light at short wavelength radiated from the light source, and thus enabling reduction in size and cost of the illumination apparatus.

What we claim is:

1. An illumination apparatus for an optical instrument comprising an illumination means outputting illumination light and an optical element which is positioned on the light path of the illumination light outputted from the illumination means and which is made of organic/inorganic composite material.

2. An illumination apparatus for an optical instrument as claimed in claim 1, wherein organic component of the organic/inorganic composite material is a component having a glass-transition temperature higher than 150° C.

3. An illumination apparatus for an optical instrument as claimed in claim 1 or 2, wherein the organic/inorganic composite material contains at least one of components represented by the following general formula (1) or (2):
R¹ₐR²_{b}Si(OR³)_{4-a-b} General Formula (1)
wherein R¹ and R² are the same or different organic groups, R³ is an alkyl group, an alkyl halide group, an aryl group or an aryl halide group of which carbon number is between 1 and 6, and “a” and “b” are integers between 0 and 2 and “a+b” is an integer between 0 and 2;
M¹(OR⁴)ₙ General Formula (2)
(M¹ is at least one of metal elements which is selected from a group consisting of Al, Be, Ge, Hf, La, Mg, Sc, Ta, Ti, V, Y, Zn, and Zr, R⁴ is an alkyl group, an alkyl halide group, an aryl group or an aryl halide group of which carbon number is between 1 and 6, and “n” is a positive integer as a valence of the metal element M¹).

4. An illumination apparatus for an optical instrument as claimed in claim 1, wherein the organic/inorganic composite material contains a component having a glass-transition temperature higher than 150° C. as its organic component and a component capable of transmitting lights in a range including the visible wavelength range and the ultraviolet wavelength range as its inorganic component.

5. An illumination apparatus for an optical instrument as claimed in claim 4, wherein the organic/inorganic composite material contains at least one of components represented by the following general formula (3) or (4):
R¹ₐR²_{b}Si(OR³)^{4-a-b} General Formula (3)
wherein R¹ and R² are the same or different organic groups, R³ is an alkyl group, an alkyl halide group, an aryl group or an aryl halide group of which carbon number is between 1 and 6, and “a” and “b” are integers between 0 and 2 and “a+b” is an integer between 0 and 2;
M²(OR⁴)ₘ General Formula (4)
(M² is at least one of metal elements which is selected from a group consisting of Al, Be, Hf, La, Mg, Sc, Y, and Zr, R⁴ is an alkyl group, an alkyl halide group, an aryl group or an aryl halide group of which carbon number is between 1 and 6, and “m” is a positive integer as a valence of the metal element M₂).

6. An illumination apparatus for an optical instrument as claimed in any one of claims 1 through 5, wherein the illumination apparatus for the optical instrument is an illumination apparatus for a microscope.
